(19) United States
(12) Patent Application Publication
(10) Pub. No.: US 2026/0251855 A1
(43) Pub. Date: Aug. 27, 2026

(54) Push-pull tail sleeve for optical fiber connectors

(71) Applicant: ACCELINK TECHNOLOGY CO., LIMITED, NT (HK)

(72) Inventor: Da Meng, NT (HK)

(21) Appl. No.: 19/192,892

(22) Filed: Apr. 29, 2025

(30) Foreign Application Priority Data
Feb. 24, 2025 (CN) 202520296238.7

(51) Int. Cl. G02B 6/38

(52) U.S. Cl. CPC G02B 6/3893; G02B 6/381; G02B 6/38875

(57) ABSTRACT

A push-pull tail sleeve for an optical fiber connector, comprising a tail sleeve body, exhaust grooves, and latches. The number of exhaust grooves is four, evenly distributed on both sides of the tail sleeve body. Similarly, the number of latches is four, evenly distributed on both sides of the tail sleeve body, with the latches positioned above the exhaust grooves. A protective sleeve is fixedly connected at the tail end of the tail sleeve body. Compared with existing technologies, the advantages of the present invention lie in its ability to facilitate simpler and more convenient plugging and unplugging operations using the push-pull tail sleeve for connectors in complex environments with limited space, thereby increasing work efficiency.

### 1. TECHNICAL FIELD

The present invention relates to the field of connector devices, specifically to a push-pull tail sleeve for optical fiber connectors.

### 2. BACKGROUND ART

The push-pull tail sleeve is a critical component of optical fiber connectors (such as LC, SC, MPO, etc.). It utilizes a push-pull mechanical structure to enable rapid locking and unlocking of the connector. At the same time, it encases the tail fiber to prevent bending damage and the impact of external stress.

With the rapid development of cloud computing, big data, artificial intelligence, and other technologies, the scale of data centers and data traffic continue to increase, imposing higher requirements on the transmission capacity and density of optical fiber communication systems. MPO connectors, as a type of high-density optical fiber connector, have emerged and been widely adopted. In order to better adapt to the high-density installation and rapid deployment needs of data centers, a push-pull boot design has been introduced into MPO connectors.

Currently, in high-density optical fiber cabling environments, such as data centers, the space between connectors is very limited, and complex rotation or screwing operations reduce work efficiency.

### 3. SUMMARY OF THE INVENTION

The technical problem that the present invention aims to solve is to overcome the aforementioned technical deficiencies by providing a connector pull-tail sleeve device that can be used in complex environments with limited space.

### Technical Solution of the Invention

To address the aforementioned issues, the technical solution of the present invention is a fiber optic connector push-pull tail sleeve comprising a tail sleeve body, exhaust grooves, and latches;

The number of exhaust grooves is four, evenly distributed on both sides of the tail sleeve body. The number of latches is also four, evenly distributed on both sides of the tail sleeve body, positioned above the exhaust grooves. A protective sleeve is fixedly connected at the tail end of the tail sleeve body.

The combined length of the tail sleeve body and the protective sleeve is 44 mm, with a width of 11.3 mm and a height of 10.6 mm.

Compared to existing technologies, the advantages of the present invention are as follows:

Convenient Plug-and-Play Operation: The push-pull tail sleeve design facilitates the plugging and unplugging of the connector. Users can simply push or pull the tail sleeve to connect or disconnect the connector, eliminating the need for complex rotation or screwing operations, thereby enhancing work efficiency.

Enhanced Stability and Reliability: Once inserted into place, the tail sleeve can lock the connector in a connected state through a specific mechanical structure, preventing accidental disconnection due to touching or vibration, ensuring the stability and reliability of the connection. In high-density fiber optic cabling environments, the push-pull tail sleeve design allows for more compact plugging and unplugging operations, reducing the space requirements around the connector and facilitating the installation of more connectors in limited spaces.

In summary, the present invention addresses the challenges faced in high-density fiber optic cabling environments by providing a push-pull tail sleeve design for fiber optic connectors that enhances operational convenience, stability, and space efficiency.

### 4. BRIEF DESCRIPTION OF ACCOMPANYING DRAWINGS

FIG. 1 is a three-dimensional view 1 of a push-pull tail sleeve for an optical fiber connector according to the present invention;

FIG. 2 is a three-dimensional view 2 of a push-pull tail sleeve for an optical fiber connector according to the present invention.

As shown in the figures: 1. Tail sleeve body; 2. Exhaust groove; 3. Latch; 4. Protective sleeve.

### 5. SPECIFIC EMBODIMENT OF THE INVENTION

The following further describes the specific embodiment of the present invention in conjunction with the accompanying drawings. Identical components are denoted by the same reference numerals.

It should be noted that the terms “front”, “rear”, “left”, “right”, “top” and “bottom” used in the following description refer to the directions in the accompanying drawings, while the terms “inner” and “outer” respectively refer to directions towards or away from the geometric center of a specific component.

To facilitate a clear understanding of the content of the present invention, the following provides a clear and complete description of the technical solution in the embodiment of the present invention in conjunction with the drawings of the embodiment.

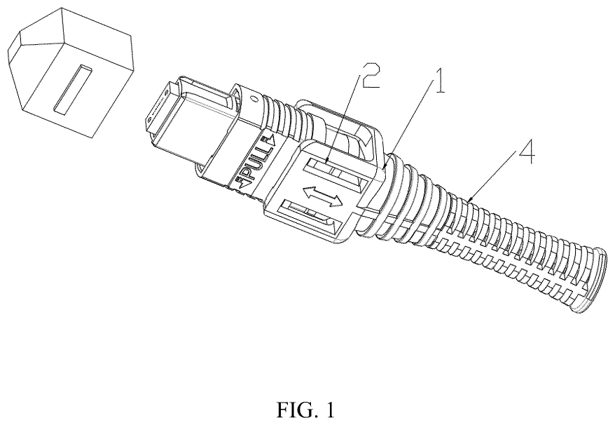

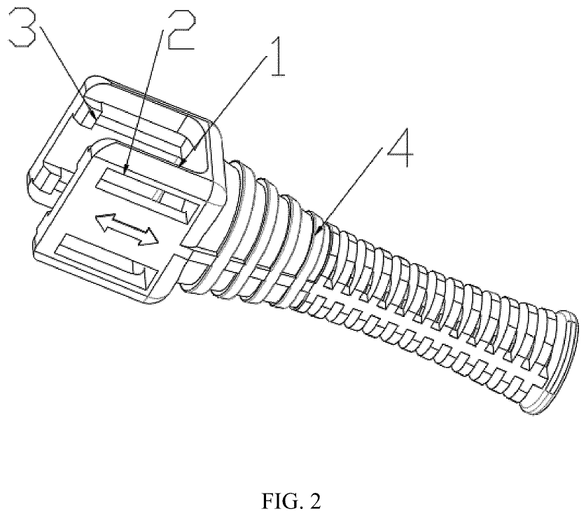

As shown in FIGS. 1 to 2, a push-pull tail sleeve for an optical fiber connector includes a tail sleeve body 1, exhaust grooves 2, and latches 3. The number of exhaust grooves 2 is four, evenly distributed on both sides of the tail sleeve body 1. The number of latches 3 is also four, evenly distributed on both sides of the tail sleeve body 1, with the latches 3 positioned above the exhaust grooves 2. A protective sleeve 4 is fixedly connected at the tail end of the tail sleeve body 1. The combined length of the tail sleeve body 1 and the protective sleeve 4 is 44 mm, with a width of 11.3 mm and a height of 10.6 mm.

In practical applications, in high-density fiber optic cabling environments such as data centers, the space between connectors is very limited. The push-pull tail sleeve design allows for more compact plugging and unplugging operations of connectors, reducing the space requirements around them and facilitating the installation of more connectors in limited spaces. The push-pull tail sleeve design also makes the plugging and unplugging operations of connectors more convenient. Users can simply push or pull the tail sleeve to connect or disconnect the connector without complex rotation or screwing operations, thereby improving work efficiency.

As shown in FIG. 1, the exhaust grooves 2 prevent weld lines from weakening the mechanical strength of the product. During the injection molding process, plastic melt flows in the mold cavity and encounters obstacles or forms weld lines due to different flow paths. The exhaust structure optimizes gas venting, enabling the melt to better fuse together, reducing the problem of reduced weld line strength due to gas obstruction, and improving the mechanical properties and appearance integrity of the product. There are four latches 3 inside the product cavity. The latches 3 are embedded into the outer frame sleeve of the optical fiber connector for tight fitting. After assembling the tail sleeve body 1, users can simply push or pull the tail sleeve to connect or disconnect the connector without complex rotation or screwing operations.

By following the above embodiment, the present invention can be well implemented. It is worth noting that based on the above design principle, even if some non-essential modifications or embellishments are made to the structure disclosed in the present invention, they still fall within the protection scope of the present invention if they address the same technical issues.

The above description of the present invention and its embodiment is not limiting. The drawings only show one embodiment of the present invention, and the actual structure is not limited to this. In summary, if ordinary technicians in the field are inspired by this and, without departing from the principles of the present invention, design similar structural methods and embodiments without creative effort, they should all fall within the protection scope of the present invention.

1. A push-pull tail sleeve for optical fiber connectors, characterized in that it comprises a tail sleeve body (1), exhaust grooves (2), and latches (3);
number of the exhaust grooves (2) is four, evenly distributed on both sides of the tail sleeve body (1);
number of the latches (3) is also four, evenly distributed on both sides of the tail sleeve body (1); the latches (3) are positioned above the exhaust grooves (2);
A protective sleeve (4) is fixedly connected at the tail end of the tail sleeve body (1).

2. The push-pull tail sleeve for optical fiber connectors according to claim 1, further characterized in that sum of the length of the tail sleeve body (1) and the length of the protective sleeve (4) is 44 mm, with a width of 11.3 mm and a height of 10.6 mm.
